(19) United States
(12) Patent Application Publication
(10) Pub. No.: US 2005/0233790 A1
(43) Pub. Date: Oct. 20, 2005

(54) Pool video game

(76) Inventor: Boris Itskov, Thornhill (CA)

Correspondence Address: Dennison Associates;Suite 301, 133 Richmond Street West, Toronto, ON, M5H 2L7, CA

(21) Appl. No.: 11/052,083

(22) Filed: Feb. 8, 2005

(30) Foreign Application Priority Data
Mar. 30, 2004 (CA) 2,462,620

(51) Int. Cl. A63F 13/00

(52) U.S. Cl. 463/2

(57) ABSTRACT

An improved system and method for inputting pool shot instructions for a video game utilize a touch screen and a monitoring arrangement for detecting a player's instruction that a particular proposed shot is to be implemented. The system and method preferably allows shot information to be inputted in a traditional manual type mode or in an automatic mode. The automatic mode generally simulates the action of a pool shot in a conventional pool game, and preferably provides on screen feedback of the proposed direction of the shot prior to the instruction to implement the shot. The automatic mode is easily learned and allows shots to be completed in a different and often more time efficient manner.

### FIELD OF THE INVENTION

The present application is directed to video game terminals and in particular, to video game terminals for playing of games using a touch screen.

### BACKGROUND OF THE INVENTION

Video game terminals for playing one of a series of different games where a player provides input to the game via the touch screen are currently in use.

A host of different types of games are available for these game terminals including simulated billiards or pool games. In such pool games, the touch screen includes a depiction of the playing surface of a pool table with the various balls on the playing surface. A player controls a simulated pool cue to determine the direction of movement of a particular ball on the surface and sets a speed or a force component for striking of the ball. Thus, both direction and speed of the ball are controlled by the player. Typically the player positions the cue in a desired position and angle for a particular shot. The player then sets the force component using a sliding scale setting or other input.

The shot is actuated by pressing a “shoot” button for striking of the ball according to the set components. The game implements the shot and displays the result of the ball striking other balls, etc. on the game surface. Once the balls come to rest, the process is repeated. Therefore, with simulated pool type games, a cue is approximately positioned relative to a ball for striking thereof and a force component is associated with the pool shot.

These systems provide good control of the “shot”, however, the player input requirements are somewhat time consuming and awkward. Most video games are designed to start and finish within a relatively short period of time, for example, two to four minutes. The known input procedure is not entirely satisfactory.

The present invention seeks to provide a more effective procedure for inputting player shot information to a pool type game or other game requiring similar shot type input.

### SUMMARY OF THE INVENTION

A method of inputting shot information for play of a simulated pool game on a touch screen display according to the present invention comprises the steps of:
using a touch screen to display a depiction of a pool table with a plurality of balls thereon,
detecting an initial point of contact of the touch screen on one of said balls followed by movement to a current point of contact a distance away from the initial point of contact while maintaining contact with the screen,
providing feedback on said screen of a proposed movement of said contact ball in accordance with the relationship of said current point of contact and said initial point of contact,
monitoring said touch screen for detection of a release of said current point of contact indicative of an instruction to implement proposed movement of said contacted ball in accordance with said relationship,
calculating movement of said balls based on a detection of a release of said current point of contact, and
displaying on said screen said calculated movement of said balls.

According to an aspect of the invention, the step of calculating movement of said balls includes evaluation of the angular position and distance between said initial point of contact and said current point of contact.

In a further aspect of the invention, the calculated movement of said balls includes an initial direction of movement of said contacted ball based on the angular position of said initial and said current points of contact.

According to a preferred aspect of the invention, the calculated movement of said balls includes a speed component based on the distance between said points.

Preferably, the method includes a separate arrangement for inputting a spin on the contacted ball to vary the movement thereof.

In a further aspect of the invention, the method is carried out on a repeated basis for completing a series of shots as part of a simulated game of pool.

In a different aspect of the invention, the simulated game has a series of separate rounds where a predetermined number of balls must be pocketed to successfully complete the round.

In a preferred embodiment of the invention, the method includes an alternate arrangement comprising a series of steps for inputting shot information and said alternate arrangement is selectable by a player.

Preferably, the alternate arrangement includes the steps of selecting a ball to shoot by touching a ball displayed on said touch screen and displaying a positionable cue on said screen associated with said selected ball, moving said cue to control the direction of the shot, using said touch screen to set a speed component for said shot, and using said touch screen to actuate a shot by touching said screen in a predetermined location, and displaying the movement of said balls as a result of said shot.

### BRIEF DESCRIPTION OF THE DRAWINGS

Preferred embodiments of the invention are shown in the drawings, wherein:

FIG. 1 shows an initial game screen presented to a player having a series of different games available in one column and a brief summary of the object and rules associated with the particular game “Silver Cue”;

FIG. 2 is an information screen showing the playing surface for the game “Silver Cue” and providing information with respect to the playing of the game;

FIG. 3 is an initial game screen of “Silver Cue” where the player is advised that the game is presently in the “auto shoot” mode;

FIG. 4 is a further game screen similar to FIG. 3 where the game has been placed in the “manual shoot” mode;

FIG. 5 is a game screen shot during play of the game “Silver Cue” in the “auto shoot” mode;

FIG. 6 is a table showing the requirements of the game in different difficulty levels of plays;

FIG. 7 is a game screen available to a player for selecting the difficulty levels;

FIG. 8 is a game screen indicating the maximum available shots have been met;

FIG. 9 is a game screen indicating time has expired;

FIG. 10 is a game screen indicating an invalid shot has occurred; and

FIG. 11 is a logic chart regarding the “auto shoot” mode.

### DETAILED DESCRIPTION OF THE PREFERRED EMBODIMENTS

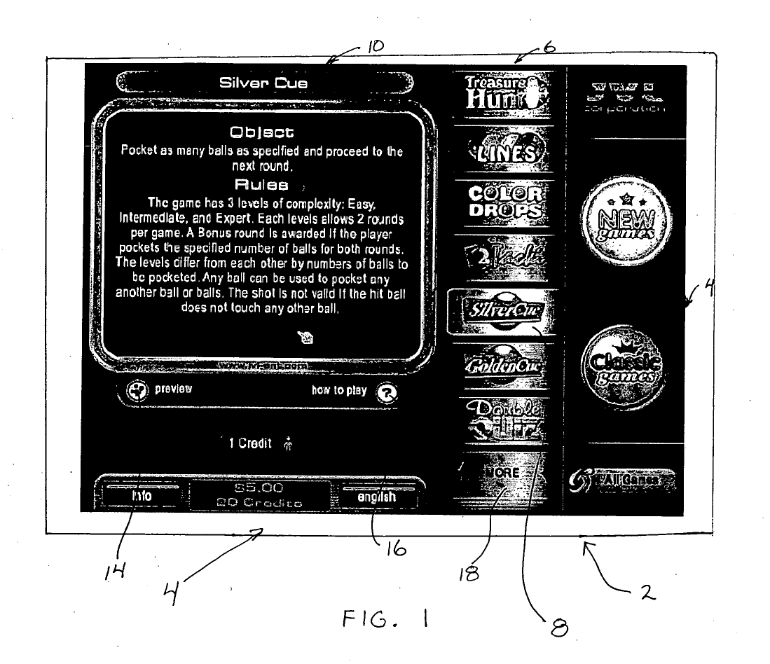

A game terminal 2 is partially shown in FIG. 1 and includes the touch screen 4. The video game terminal includes a computer having its own processing arrangement, random access memory, mass storage arrangement, as well as communication protocol. These components are not shown as the game terminal is well known.

The touch screen 4, as shown in FIG. 1, displays an initial game screen where a potential player has selected by touching the particular game “Silver Cue” identified as 8. An explanation of the selected game is provided at 10. The title “Silver Cue” is shown at the top of the touch screen and the general object of the game and the rules of the game are set out. The touch screen provides a list 6 of other games which are available for selection, as well as a “more” button 18 which allows the player to see additional games for selection.

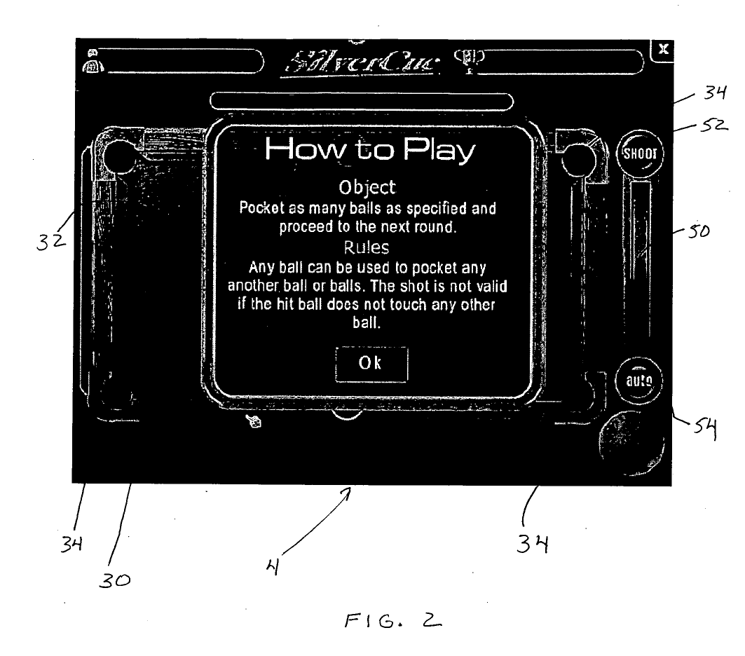

FIG. 2 shows the touch screen after the player has selected the “how to play” actuator 16 of FIG. 1 and additional game information is provided. In this case there is a statement that the object of the game is to pocket as many balls as specified and proceed to the next round. In this particular game, any ball can be used as a cue ball to pocket any other ball or balls. It is a requirement of the game that the ball struck by the player must strike another ball. Any pocketed ball is desirable including the cue ball assuming it first strikes another ball.

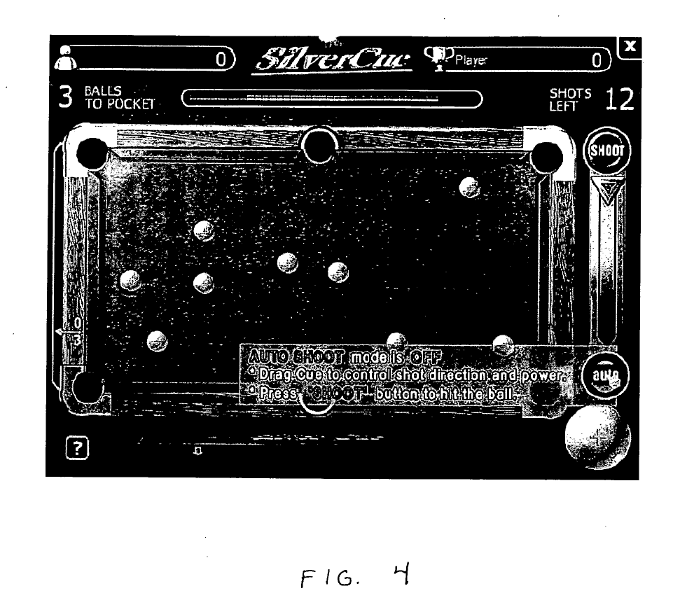

In FIG. 2 the touch screen 4 displays a general outline of the game table 30 having a playing surface 32 and a series of six pockets 34. Provided at the extreme right of the touch screen is a control bar 50 used to manually set a force component for the particular shot as well as a “shoot” button 52 for manually initiating the particular shot. These controls are for the traditional manual shot input procedure. The “manual” mode is shown in FIG. 4.

An “auto” button 54 is actuated for selecting the “auto shoot” mode. In the “auto shoot” mode the player's input to the touch screen determines both the direction of the shot and the force component thereof. In the “manual” mode, the player sets the particular force value and sets the direction of the shot and when satisfied with these set inputs which are shown on the screen, the player then actuates the “shoot” button 52. This is in contrast to the “auto shoot” mode where the player effectively touches a ball to select it as a cue ball for shooting, and maintains his finger in contact with the touch screen to set a particular angle and force for the shot based on the initial ball contacted and the end position of finger contact relative to the contacted ball. This end position of finger contact is the position where the player releases finger contact with the screen. The initial contacted ball and the end contact position determines the direction of the shot. The distance between the initial ball contacted and the end position determines the force. The input to initiate the shot is provided by the player releasing finger contact with the touch screen. Thus, while the player maintains finger contact with the touch screen, adjustments to the direction and force of the shot are continuously made until such time as the finger contact with the touch screen is terminated.

This “auto shoot” mode provides a convenient and time effective procedure for the player to input the particular shot requirements and the game to be completed in a smooth intuitive manner. It should be noted that this action is very similar to the action required in an actual pool game where the player places one hand close to the ball to guide the cue for striking of the ball, positions the cue at a particular angle to determine the shot direction, and draws the cue back and advances it forward to strike the ball with a particular force component.

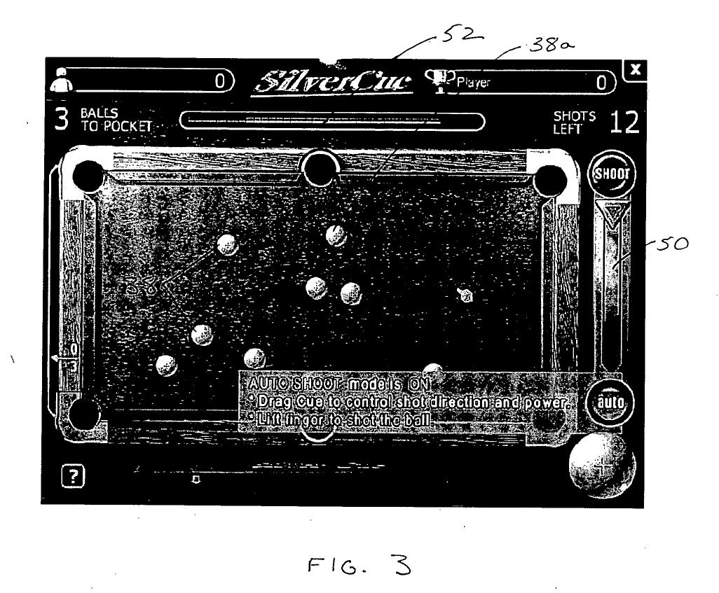

As will be more fully described with respect to FIG. 3, the game Silver Cue allows the player to choose any ball as a cue ball merely by touching it and once this has been initiated in the “auto shoot” mode, the player is then committed to shoot that particular ball. The player determines the particular angle and force by maintaining contact with the touch screen and moving to a desired end point and then releasing his finger from the touch screen.

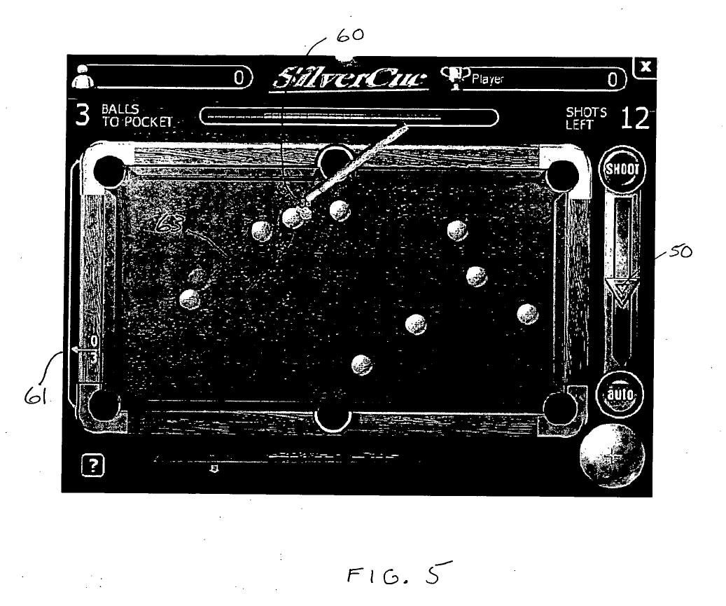

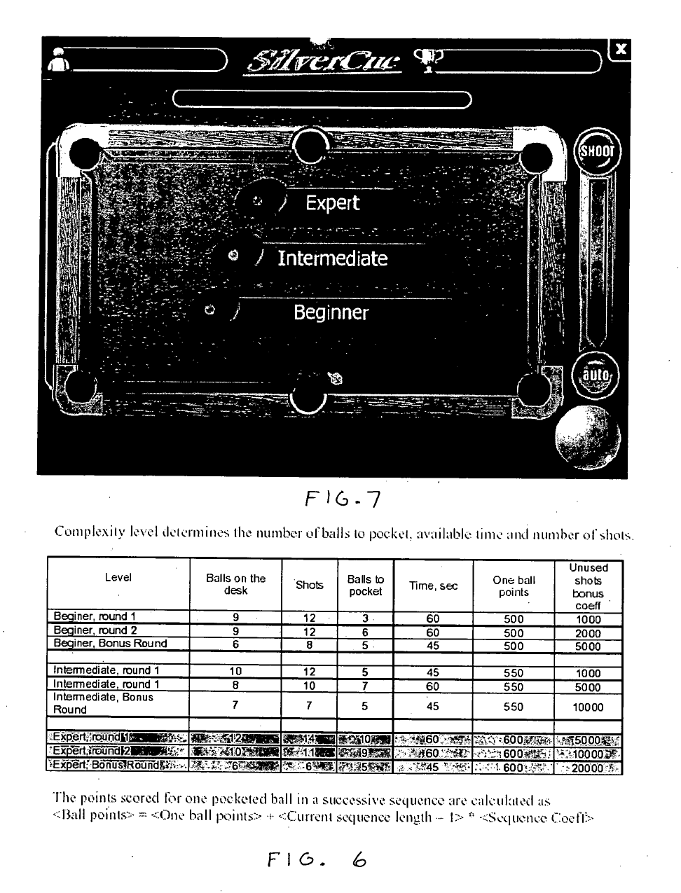

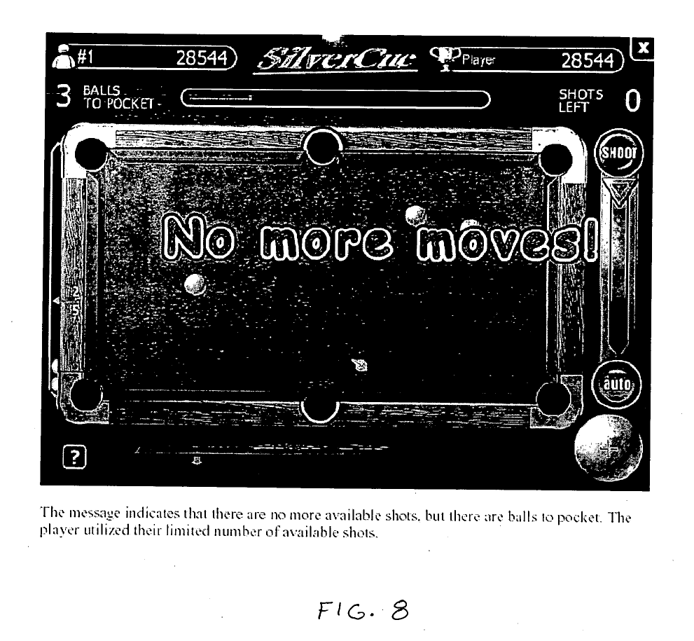

In a preferred embodiment as shown in FIG. 5, the proposed direction of movement of the cue ball is shown by a shadow line. This allows the player to make any adjustments prior to shooting the ball.

In the “auto shoot” mode as shown in FIG. 5, the force actuator 50 includes a slide adjustment showing the particular force component and this force actuator 50 continues to reflect changes in this force component due to the end position of the player's contact point. In a preferred embodiment, a value of the force in the scale from 0 to 100 is also provided. This is indicated in FIG. 5 as item 60 with a current value of 52. To the left side of the touch screen and associated with the depiction of the playing surface, is a slide indicator 61 showing the balls required in this round to be pocketed, namely three balls to be pocketed and an indication of how many balls have been pocketed to date. In this case “0” is shown as no balls have previously been pocketed. Each round is timed and therefore the ability for the player to easily input particular shot variables in a precise and efficient manner is helpful. The pool game includes a number of different levels of play and the difficulty settings are typically “beginner”, “intermediate” and “expert”. These can be set by the operator or by the individual players.

In FIG. 3, it can be seen that the player is about to initiate the game and the playing screen has advised the player that the “auto shoot” mode is “on”. The player can accept this setting by touching the “auto” button or by touching the “on” symbol in the warning. If the player wishes to enter the manual mode, he can touch the “shoot” button provided at the top right of the screen. If this is pressed, the warning will change to “auto shoot mode is off” as shown in FIG. 4. Acceptance of this setting is indicated by touching the “shoot” button.

Play of the game Silver Cue is easily carried out and will be explained with respect to FIG. 5. It is assumed that the player has now confirmed the “auto shoot” mode button provided at the right, lower left, and the game surface is shown with a series of balls 38 distributed thereabout and any of these balls can be used as a cue ball for striking any other ball. In this case, the player has touched ball 38a and moved his finger away from the ball towards the right and slightly up. This action has produced a particular force component 60 with a value of 52 shown near the cue and it has also produced a shot direction indicated by the line 63. If the player moves his finger to a different end position, a different force and direction is shown on the touch screen. A decision to shoot is recognized by the game when the player removes finger contact with the touch screen.

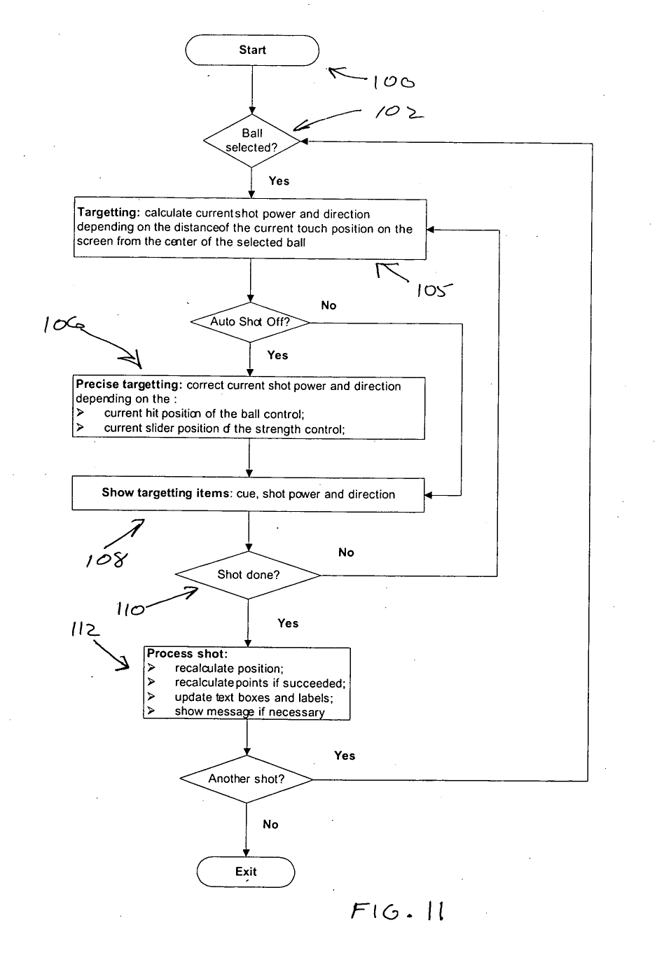

Initiation of the shot causes the ball to move across the playing surface and collide with other balls on the surface, hopefully in a desired manner. Any ball which is deposited in a pocket after contact with another ball is a desirable shot. The goal is to pocket a certain number of balls within a particular time period. The game is divided into round one and round two. If the player successfully completes round one and round two (by pocketing the required balls in the allotted time), a “bonus” round is provided. If the player “scratches”, which occurs by either directly causing the cue ball to be deposited in a pocket without contact with any other ball, or where the shot results in the particular selected cue ball not striking any other ball, a time penalty is imposed on the player. The game displays the “scratch screen” shown in FIG. 10, indicating that an illegal shot has been made. The game subsequently returns the player to the game screen where a new shot may be made. Given that the rounds are timed and a player must complete a certain number of pocketed balls within a time period, this scratch screen causes a disadvantage to the player which is appropriate as the shot was illegal. As can be appreciated, it is also possible to alter the game rules and stop the game if such an illegal “scratch” is determined or assign a penalty in a different manner.

As previously outlined, it is also possible to complete this game in the “manual shoot” mode. The “manual shoot” mode is initiated by the player touching the shoot button before any contact with a cue ball. Therefore, a player can easily go from “auto shoot” mode to “manual shoot” mode during a game. In the “manual” mode the player touches a particular ball which he desires to shoot and a cue is shown in close proximity to the ball. This cue can be moved away from the ball to produce a particular shot direction. The direction can be varied by the player merely touching the cue and causing it to move across the screen. The direction is determined by the cue position and the position of the contact ball. The force component can be set on the slide scale 50. Once the player decides the shot is correct, he presses the “shoot” button. With this method it is not necessary for the player to maintain finger contact with the touch screen. He can touch the cue ball, remove contact from the screen, move the cue to the desired position and release contact with the touch screen, set the force value, and make any other adjustments he desires and then actuate the “shoot” button. If he desires to cancel this particular shot and select a different ball for shooting, he is free to do so. In the “auto” mode, it is preferred once a particular ball has been touched, this ball will be shot, assuming time does not run out. To go from “manual” mode to “auto shoot” mode, the player merely touches the “auto” button.

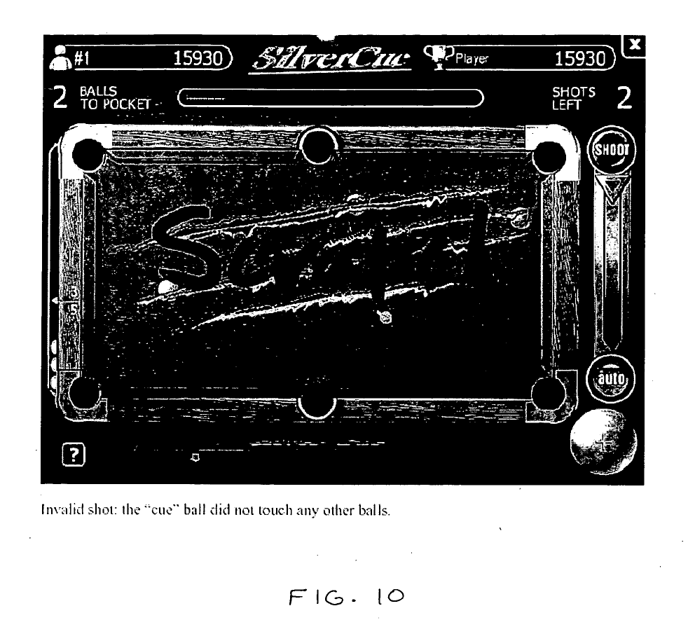

A table showing different parameters for round one, round two and the bonus round are shown in FIG. 6 where the number of balls on the playing surface to start the particular round, as well as the number of shots available and time available for the particular round, are all shown. Performance of the particular round can be based on time remaining and points for the balls that have been deposited in the pockets. In addition, additional points can be used for sinking of the particular number of balls in an efficient manner, i.e. without many additional shots. Different ways for calculating these points are shown. As can be seen in the set up screen of FIG. 9, the player can select between “expert”, “intermediate” and “beginner”.

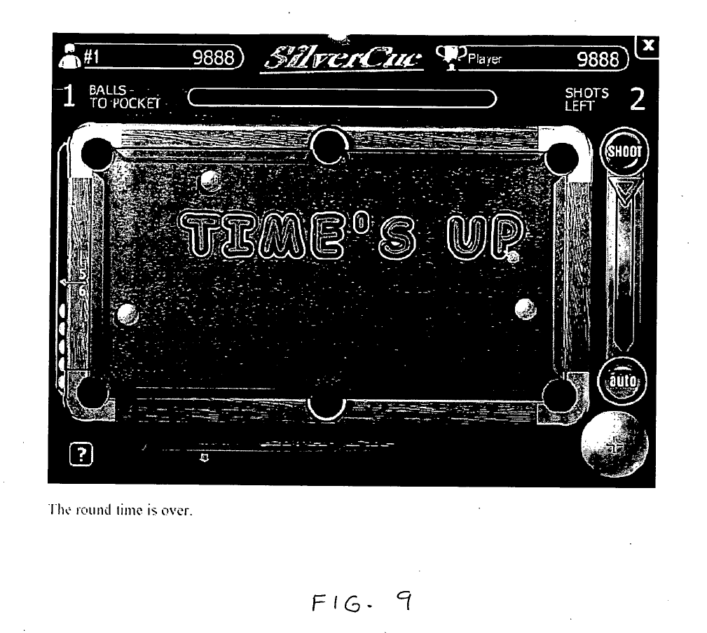

The screen of FIG. 8 indicates that the player has completed the greatest number of shots available for the particular round. The round is over, regardless of the time.

In FIG. 9 the player is presented with a game screen indicating that the time for the particular round is over.

FIG. 10 indicates that an illegal scratch has occurred.

The touch screen also provides a running score for the particular player. The game can be played with one or several players. In addition, it can be seen that the “pocketed” balls, such as the balls shown in FIGS. 8, 9, and 10 are provided in the ball rack indicated at the left side. For example, in FIG. 10, three balls have been pocketed and based on the ratio, two more balls are required to be pocketed to complete the current round.

This particular “auto shoot” mode for inputting a shot having a number of different variables, direction and force, is easily provided in an effective, intuitive manner. This shot procedure can also be used for other games which require a striking of a first object towards one or more objects. For example, this shot mechanism input would also be useful for a simulated game of bowling or a shooting game.

A further variable for the pool game can be inputted using the “spin control” ball provided at the lower right hand side. The cross provided at the center of the ball, indicates that the cue is striking the ball in the center position. It is possible to apply spin to the ball such as top right spin, top left spin, bottom left spin, bottom right spin, center top or center bottom spin, to cause the struck ball to act in a particular manner. This provides a simulated spin and change in direction of the ball as would occur in an actual pool game. Thus this ball allows the player to provide “English” on the selected cue ball.

The “shot input” procedure has been described in particular, with the shot procedure. The desired game “Silver Cue” where any ball can become a selected cue ball. It is also appreciated that this procedure can also be used for playing of a pool game involving a standard type cue ball or cue balls being depicted on the game surface.

FIG. 11 shows a general flow chart of the logic associated with each shoot procedure. The start box 100 is in effect the terminal waiting for shot information. If a ball is selected at 102, a player has touched a particular ball for shooting thereof. If the answer is yes, then the program determines whether the “auto shoot” mode is “on” and if so, monitors the position of the player's finger on the touch screen relative to the initial position. This monitoring step is carried out at 106. At 104 the program then calculates the particular force and the particular direction of the possible shot based on the initial position and the present end position, i.e. the point of contact with the touch screen. This calculates the direction and speed of the shot based on these two points. This information is displayed on the screen at 108.

Optionally, the program will show the direction of the ball for striking a subsequent ball by means of a “shadow line” and a “shadow ball”. The program continues to monitor the end position of the player's finger. In particular at 110, to the program determines whether the finger contact has been released from the touch screen. Once the finger contact has been released from the touch screen the shot is fired as indicated at 112.

If the answer is “no”, i.e. the finger is still in contact with the touch screen, then at 110 the program determines whether the end point has changed. If the end point has changed, the program returns to the targeting stop at 105 where a new calculation of direction and speed is made. If the position hasn't changed, the program continues to monitor for a change in position or a determination that the finger has been released from the touch screen.

Once the finger has been released from the touch screen, the shot is effectively made. The program then determines what collisions will be made, what balls will be contacted and moved and causes the balls to move in the particular manner across the screen for striking one another and for deposit in any pockets. Once the balls stop moving on the screen, the process can then be repeated. The program continues to monitor the movement of the balls with the completion of the shot at Box 112. Once it has been determined the shot has been completed, the process is repeated.

In the “manual” mode, the steps at 106 are bypassed. The flow chart of FIG. 11 illustrates how a player can select the “manual” or the “auto” mode at the initiation of any shoot.

Although various preferred embodiments of the present invention have been described herein in detail, it will be appreciated by those skilled in the art, that variations may be made thereto without departing from the spirit of the invention or the scope of the appended claims.

1. A method of inputting shot information for play of a simulated pool game on a touch screen display according to the present invention comprises the steps of:
showing a depiction of a pool table with a plurality of balls thereon,
detecting an initial point of contact of the touch screen on one of said balls followed by movement to a current point of contact a distance away from the initial point of contact while maintaining contact with the screen,
providing feedback on said screen of a proposed movement of said contact ball in accordance with the relationship of said current point of contact and said initial point of contact,
monitoring said touch screen for detection of a release of said current point of contact indicative of an instruction to implement proposed movement of said contacted ball in accordance with said relationship,
calculating movement of said balls based on a detection of a release of said current point of contact, and
displaying on said screen said calculated movement of said balls.

2. A method as claimed in claim 1 wherein the step of calculating movement of said balls includes evaluation of the angular position and distance between said initial points of contact and said current point of contact.

3. A method as claimed in claim 2 wherein said calculated movement of said balls includes an initial direction of movement of said contacted ball based on the angular position of said initial and said current points of contact.

4. A method as claimed in claim 3 wherein said calculated movement of said balls includes a speed component based on the distance between said points.

5. A method as claimed in claim 4 including a separate arrangement for inputting a spin on the contacted ball to vary the movement thereof.

6. A method as claimed in claim 1 carried out on a repeated basis for completing a series of shots as part of a simulated game of pool.

7. A method as claimed in claim 6 wherein said simulated game has a series of separate rounds where a predetermined number of balls must be pocketed to successfully complete the round.

8. A method as claimed in claim 7 wherein each round must be completed in a predetermined time period.

9. A method as claimed in claim 1 includes an alternate arrangement comprising a series of steps for inputting shot information and said alternate arrangement is selectable by a player.

10. A method as claimed in claim 9 wherein said alternate arrangement includes the steps of selecting a ball to shoot by touching a ball displayed on said touch screen and displaying a positionable cue on said screen associated with said selected ball, moving said cue to control the direction of the shot, using said touch screen to set a speed component for said shot, and using said touch screen to actuate a shot by touching said screen in a predetermined location, and displaying the movement of said balls as a result of said shot.
